(19) United States
(12) Patent Application Publication
(10) Pub. No.: US 2025/0044755 A1
(43) Pub. Date: Feb. 6, 2025

(54) APPARATUS FOR CONTROLLING A PROCESS FOR PRODUCING A PRODUCT

(71) Applicant: BASF SE, Ludwigshafen Am Rhein (DE)

(72) Inventor: Gimmy Alex FERNANDEZ RAMIREZ, Ludwigshafen (DE)

(21) Appl. No.: 18/722,565

(22) PCT Filed: Dec. 20, 2022
(86) PCT No.: PCT/EP2022/087069

§ 371 Date: Jun. 21, 2024

(30) Foreign Application Priority Data
Dec. 21, 2021 (EP) 21216645.8

(51) Int. Cl. G05B 13/04; G05B 13/02

(52) U.S. Cl. CPC G05B 13/042; G05B 13/0265

(57) ABSTRACT

The invention refers to an apparatus 110 for controlling a process for producing a substance by coupled chemical reactors 131, 132 being coupled with respect to an operation parameter. An efficiency model providing unit 111 provides a model for each reactor providing a simulated efficiency of each reactor based on the operation parameter. An optimization model providing unit 112 provides a model providing an optimizable function of a substance output of the reactors depending on the operation parameter and the efficiency of the reactors. An optimization unit 113 optimizes the substance output by utilizing the simulated efficiency models and the respective simulated efficiencies in the optimization model for determining an optimized operation parameter that optimizes the substance output of the reactors, and a control signal providing unit 114 provides a signal indicative of the optimized operation parameter to control the operation of the reactors.

### FIELD OF THE INVENTION

The invention refers to an apparatus, a production system comprising the apparatus, a method and a computer program product for controlling a process for producing a product. Further, the invention refers to an apparatus, a method and a computer program product for training a simulated efficiency model.

### BACKGROUND OF THE INVENTION

In modern chemical production it is often common to produce a chemical product and in parallel using two or more coupled chemical reactors. Such coupled production is often necessary when huge volumes of the chemical product shall be produced with only a limited reactor space or when the chemical reaction for producing the chemical product is performed more efficiently in respective smaller volumes. In most application cases the coupled chemical reactors are then coupled with respect to at least one operation parameter, wherein in most cases this operation parameter refers to at least a substance input into the at least two reactors but can also refer to any other operation parameters of the reactors, for instance, to a temperature. It can be shown that although such coupled chemical reactors utilize the same chemical process and comprise normally the same general build, in reality both reactors will not provide the same efficiency. This can be caused, for instance, by different catalytic activities, small differences in the not coupled operation parameters, or other influences that are often not easily measurable. Thus, operating two coupled reactors, in particular, controlling the coupled operation parameter to maximize the output of the produced chemical product is often a very complex task and strongly depends on the experience of the operator. However, even if the operator is quite experienced, still in many cases the control and operation of the coupled reactors is ineffective.

It would therefore be advantageous if the coupled reactors could be operated and controlled more efficiently such that an overall production of the chemical substance produced by the reactors could be increased.

### SUMMARY OF THE INVENTION

It is an object of the present invention to provide an apparatus, a production system comprising the apparatus, a method and a computer program product that allow to increase the controlling efficiency such that an overall production of a chemical product produced by at least two coupled reactors is increased. Moreover, it is an object of the present invention to provide a training apparatus, a training method and a computer program product for training a simulated efficiency model for each of the at least two coupled reactors that can be utilized by the apparatus, production system, method and computer program product for controlling a process for producing a product.

In a first aspect of the present invention an apparatus for controlling a process for producing a substance is presented, wherein the process is performed at least partly by utilizing at least two coupled chemical reactors, wherein the at least two coupled reactors produce the same substance in parallel and are operated such that they are coupled with respect to at least one operation parameter, wherein the apparatus comprises a) an efficiency model providing unit for providing a simulated efficiency model for each of the at least two reactors, wherein a simulated efficiency model is adapted to determine a simulated efficiency of the respective reactor based on the at least one coupled operation parameter, wherein an efficiency of a reactor is indicative of the relation between an amount of an input to the respective reactor and an amount of the substance output produced by the respective reactor, b) an optimization model providing unit for providing an optimization model, wherein the optimization model provides an optimizable function of an overall substance output of the at least two reactors in dependency of the at least one coupled operation parameter and the efficiency of the at least two reactors, c) an optimization unit for optimizing the overall substance output by utilizing the simulated efficiency models of the at least two reactors to determine a simulated efficiency of each of the at least two reactors and by utilizing the respective simulated efficiencies in the optimization model for determining at least one optimized coupled operation parameter that optimizes the overall substance output of the at least two reactors, and d) a control signal providing unit for providing a control signal indicative of the determined at least one optimized coupled operation parameter to control the operation of that at least two reactors.

Since the optimization unit is adapted to optimize the overall substance output by utilizing the simulated efficiency models of the at least two reactors to determine a simulated efficiency of each of the at least two reactors and by utilizing the respective simulated efficiencies in the optimization model for determining at least one optimized coupled operation parameter that optimizes the overall substance output of the at least two reactors, the simulated efficiency of the two reactors can be utilized to take unknown parameters that influence the efficiency of the reactor into account during the optimization process. In particular, since for each of the at least two reactors a specific simulated efficiency model is provided adapted to the respective one of the two reactors, the efficiency can be utilized during the optimization process as indirect measure for the differences of the at least two reactors. Thus, the optimization can also take these differences into account and allows for a more accurate determination of an optimized coupled operation parameter. Thus, the operation and controlling of the at least two coupled reactors can be performed more accurately and thus more efficiently based on the optimized coupled operation parameter leading to an increase in the overall substance output of the at least two reactors.

Generally, the apparatus can be realized in form of any hardware and/or software or a combination thereof that provides the functions of the units of the apparatus as defined above. In particular, the apparatus can be realized as part or in form of one computing device but can also be realized as a distribution over a plurality of computing devices, for instance, can also be realized in form of cloud computing or in a distributed network application.

The produced substance can refer to any substance that is produced in a process including a chemical reactor. Preferably, the substance refers to butynediol, however, the substance can also refer to any other chemical product produced in a chemical reactor. Accordingly, also the at least two coupled chemical reactors can refer to any chemical reactors that are adapted to produce the respective chemical substance. The coupling of the chemical reactors refers in the context of the invention to a coupling with respect to at least one operation parameter of the respective coupled reactors while the coupled reactors produce the same substance in parallel, i.e. perform the reaction process for producing the substance at the same time. Preferably, the coupled reactors are adapted to produce the substance in a continuous production process in which the process is performed continuously, i.e. uninterrupted, based on a continuous input stream and a continuous processing of the input into the reactor to provide a continuous output stream of the respective substance. However, in other embodiments the coupled reactors can also be adapted to perform a batch production, wherein the process for producing the substance is performed in batches, i.e. discontinuous. In particular, during batch production a certain amount of input is provided to the reactors, then processed, and then the output is provided before further input is provided to the reactors.

The coupled operation parameter, i.e. the at least one operation parameter to which the at least two reactors are coupled, can refer to any operation parameter. Generally, a coupled operation parameter refers to an operation parameter that, if changed in one of the coupled chemical reactors, leads directly to a change of the operation parameter in the other chemical reactors. Generally, this coupling can be a positive coupling or a negative coupling. For example, in case of a positive coupling, if a respective coupled operation parameter is increased for one chemical reactor, the coupled operation parameter will automatically also increase for all other chemical reactors. In contrast thereto, a negative coupling refers to the case in which, if a coupled operation parameter for one chemical reactor is increased, the coupled operation parameter for the other chemical reactors will decrease. For example, a coupled operation parameter referring to an input of a substance into the reactors utilizing the same feeding source would lead to a negative coupling in which, if the substance input to one reactor is increased, the input of the substance to the other reactor is decreased by the same amount. In another example, if the coupled operation parameter refers to a temperature, this will lead in most cases to a positive coupling, in which an increase of the temperature of one reactor automatically leads to an increase of the temperature for the other reactor by the same amount. Preferably, the at least one coupled operation parameter refers to at least one of an inflow of a substance into the at least two reactors, a pressure in the at least two reactors, a temperature in the at least two reactors, an amount of a catalyst in the at least two reactors, and an amount of a reactant in the at least two reactors.

The efficiency model providing unit is adapted to provide a simulated efficiency model for each of the at least two reactors. Generally, the efficiency model providing unit can refer to or can be communicatively coupled to a long-term or short-term storage on which the simulated efficiency model is already stored and which the efficiency model providing unit can access for providing the same. Moreover, the efficiency model providing unit can also refer to a receiving unit for receiving a simulated efficiency model, for instance, from a storage or a user input device for providing the received simulated efficiency model. A simulated efficiency model provided for a reactor is adapted to determine a simulated efficiency of the respective reactor based on the at least one coupled operation parameter. In this context, the efficiency of a reactor is defined as being indicative of the relation between an amount of an input to the respective reactor and an amount of the substance output produced by the respective reactor. In a preferred embodiment, the input to the respective reactor refers to a substance that is provided to the respective reactor and consumed during the production of the substance. However, the input can also refer to an overall input comprising such a consumed substance and additional components that are not be consumed during the production of the substance, for instance, referring to catalysts that are reused.

The simulated efficiency model preferably refers to a function that allows to determine a simulated efficiency of a respective reactor based on the at least one coupled operation parameter and optionally also based on other parameters, for instance, other operation parameters that are not coupled. Generally, the simulated efficiency model can be determined based on theoretical considerations with respect to the dependency of the efficiency of a respective reactor from the at least one coupled operation parameter. For example, physical or chemical laws may allow to determine such a relation directly. However, preferably, the simulated efficiency model is determined based on historical measurement data with respect to the specific reactor. For example, for a certain time period, respective input and substance output parameters of a reactor can be measured to provide a measured efficiency of the reactor and also the respective coupled operation parameter can be measured or can be provided directly from the operation of the reactor and the simulated efficiency model can be determined by determining a relation between the measured efficiency and the coupled operation parameter. For determining such a functional relation as a simulated efficiency model, any known method for determining a relation between different measurement parameters can be utilized.

In a preferred embodiment, the simulated efficiency model is trained based on historical training data comprising the at least one coupled operation parameter and a corresponding efficiency of a respective reactor, wherein a trained simulated efficiency model is trained such that it can provide a simulated efficiency for the respective reactor based on an at least one coupled operation parameter. In this embodiment, the simulated efficiency model can utilize any known machine learning algorithm that allows the simulated efficiency model to learn a functional relation between the efficiency of a respective reactor and the at least one coupled operation parameter from the historical training data. In particular, it is preferred that the machine learning algorithm allows the use of analytical derivatives. For example, the simulated efficiency model can utilize as machine learning algorithm a linear regression, neural network, polynomial, or ALAMO regression algorithm. Moreover, although less efficient also decision tree regressions or random forest algorithms can be utilized, wherein for these it is preferred to use an optimization algorithm without derivatives, for instance, Powell's method.

The optimization model providing unit is adapted to provide an optimization model. Generally, also the optimization model providing unit can refer to or can be communicatively coupled to a long-term or short-term storage on which the optimization model is already stored and to access the storage optimization model for providing the same. Moreover, the optimization model providing unit can also refer to a receiving unit for receiving an optimization model, for instance, from a storage or a user input unit, and for providing the same, for example, to the optimization unit. The optimization model provides an optimizable function of an overall substance output of the at least two reactors in dependency of the at least one coupled operation parameter and the efficiency of the at least two reactors. In particular, the optimizable function can be determined based on theoretical considerations or can be determined based on historical data of the two reactors with respect to the overall substance output, the at least one coupled operation parameter and the efficiency of the at least two reactors. Generally, the optimizable function can depend on the coupled operation parameter directly or indirectly by the dependency of the efficiency of the at least two reactors from the coupled operation parameter. In particular, this optimizable function provides a relation among the reactors and is preferable continuous and differentiable. For instance, it can be constructed as a linear combination of the individual reactor capacities and include weighting factors based on some performance criteria. However, the optimizable function can also be chosen in any other suitable way.

The optimization unit is adapted to optimize the overall substance output of the at least two reactors by utilizing the simulated efficiency models of the at least two reactors to determine a simulated efficiency of each of the at least two reactors and by utilizing the respective simulated efficiencies in the optimization model for determining at least one optimized coupled operation parameter that optimizes the overall substance output of the at least two reactors. In particular, the optimization model can be utilized in any known suitable optimization algorithm that allows to optimize the overall substance output of the at least two reactors by optimizing at least one of the coupled operation parameters. For example, the optimization unit can be adapted to utilize an iterative approach utilizing a start value for the coupled operation parameter to determine based on the coupled operation parameter start value the simulated efficiency using the simulated efficiency models of the at least two reactors and utilizing the optimization model to determine the overall substance output based on the simulated efficiencies and the coupled operation parameter start value. Based on the overall substance output, the coupled operation parameter start value can then be amended and again an overall substance output can be determined as described above. Known iterative algorithms can be utilized for searching the coupled operation parameter space for finding a coupled operation parameter that maximizes the overall substance output and thus can be determined as respective optimized coupled operation parameter. Preferably, iteration algorithms that are based on a Newton, interior point, or gradient descent method are utilized. However, depending on the optimizable function of the optimization model, also direct solvers can be utilized that allow to directly determine an optimized coupled operation parameter that maximizes the respective overall substance output of the at least two reactors.

The control signal providing unit is adapted to provide a control signal indicative of the determined at least one optimized coupled operation parameter to control the operation of the at least two reactors. In particular, the control signal can refer to a signal that is adapted to directly control the operation of the at least two reactors, for instance, by implementing the determined optimized coupled operation parameter into the operation of the at least two reactors. However, the control signal can also lead to an indirect control of the operation of the at least two reactors, for instance, by causing an operation unit of a human operator of the at least two coupled reactors to provide the operator with the information on the determined optimized coupled operation parameter such that the operator can decide whether to implement the optimized coupled operation parameter or not. Providing the control of the operation of the at least two reactors as an interactive process with an operator can be advantageous to fulfil respective security considerations that might not allow for a directly automatic operation of the at least two reactors without human supervision.

In an embodiment, the apparatus further comprises an evaluation unit adapted to regularly evaluate the simulated efficiency model of a respective reactor, wherein the evaluation unit is adapted to receive a determined current efficiency of the respective reactor and to compare the determined current efficiency with the simulated efficiency provided by the simulated efficiency model of the reactor for the currently used at least one coupled operation parameter, wherein the optimization unit is adapted to adapt during the optimization the simulated efficiency model based on the comparison. The regular evaluation of the simulated efficiency model of a respective reactor by the evaluation unit refers to an evaluation at regular intervals, for instance, every week, every day, every hour, etc. Moreover, the regular evaluation can also refer to a continuous evaluation that can be defined as an evaluation utilizing all available data for the evaluation.

The evaluation unit can be adapted to receive the determined current efficiency, for instance, from a short-term storage on which a determined current efficiency is stored. Generally, the determined current efficiency of a reactor is based on actual measurements with respect to the respective reactor. For example, if possible, the efficiency of the respective reactor can be measured directly by measuring the respective reactor input and substance output. However, in most cases it is not possible to directly measure the efficiency of the respective reactor. In this case, it is preferred that the determined current efficiency is determined based on other measurable or known process data of the reactor. Process data can refer to any data related to the chemical process performed by a respective reactor. In particular, the process data can also refer to operation parameters.

Preferably, the apparatus comprise a soft sensor unit adapted to determine, based on current process data indicative of a current state of the process for producing the product, a current efficiency for a respective reactor and to provide the determined current efficiency for the respective reactor to the evaluation unit. The respective current process data can comprise operational parameters that determine the operation of the reactor and/or can comprise measurements of a current state of the process for producing the product. In particular, it is preferred that the current efficiency is determined based on process data comprising at least one of a volume flow of a substance at an inlet of the respective reactor, a reaction capability of a substance at the inlet of the respective reactor, a mass flow of a substance at the inlet of the respective reactor, a mass flow of a substance at the outlet of the respective reactor, and a weight fraction of a substance at the outlet of the respective reactor. The soft sensor unit can then utilize known relations between the current process data and the efficiency of a reactor to determine the current efficiency. For example, based on historical process data and historical efficiency data of a respective reactor, a principal component analysis can be performed and respective statistical methods can be utilized to determine a relation of current process data to a current efficiency of a reactor. Moreover, the soft sensor unit can also be adapted to utilize machine learning algorithms like neural networks, linear or non-linear regressions, random forests, etc. for determining the relation between a current efficiency of a reactor and the respective process data.

The evaluation unit is then adapted to compare the determined current efficiency with the simulated efficiency provided by the efficiency model of the reactor. For example, during the comparison, it can be determined if a difference between the determined current efficiency and the simulated efficiency lies above a predetermined threshold. A difference lying above a predetermined threshold can, for instance, indicate that one or more of the influences influencing the reaction performed by a reactor could have been changed in a way for which the respective simulated efficiency model has not been trained. For example, if the reactor provides a catalyst for the reaction that will lose its catalytic effect over time, the simulated efficiency model provided with respect to a fully functioning catalyst might not be accurate any more after some time. Due to the comparison between the determined current efficiency and the simulated efficiency such effects can be determined and can be taken into account by the optimization unit during the optimization, preferably, by adapting the simulated efficiency model accordingly. For example, the respective difference can be added or subtracted from the simulated efficiency model during the optimization.

In a preferred embodiment, the simulated efficiency model refers to a trained machine learning based model, wherein the adapting of the simulated efficiency model based on the comparison refers to a retraining of the simulated efficiency model, if the comparison indicates a difference between the determined current efficiency and the simulated efficiency lying above a predetermined threshold. Retraining the simulated efficiency model, if a difference between the determined current efficiency and the simulated efficiency lies above a predetermined threshold, allows to adapt the simulated efficiency model to a current state of the reactor very efficiently such that a high accuracy of the simulated efficiency model on which the optimization is based can be maintained. Preferably, the retraining comprises utilizing retraining data comprising the currently used at least one coupled operation parameter and determined current efficiency of the respective reactor and/or additional historical data of at least one coupled operation parameter used in the past and corresponding determined efficiencies from a time period with operation conditions corresponding to the current operation conditions of the reactor. For example, in some applications the reactors may traverse different phases in which the relation between the coupled operation parameter and the efficiency of the reactor changes. In this case, it can be advantageous to train the simulated efficiency model based on training data referring to one phase, i.e. one operation condition of the reactor, and to retrain the simulated efficiency model with training data from another phase, i.e. another operation condition, if the comparison indicates the phase change in the reactor. This allows to easily adapt the simulated efficiency model based on a current state, i.e. operation condition, of the reactor. Moreover, alternatively, the retraining can also comprise accessing a simulated efficiency model storage on which simulated efficiency models for different operation conditions, for instance, for different known phases of the reactor, have already been trained and to provide a respectively trained stored simulated efficiency model as retrained simulated efficiency model.

In a further aspect of the invention, a production system for producing a substance is presented, wherein the production system comprises a) at least two chemical reactors adapted to perform at least parts of the process for producing the substance, wherein the at least two coupled reactors are adapted to be operated such as to produce the substance in parallel and such that they are coupled with respect two at least one operation parameter, b) an operation unit adapted to provide operation control signals to the at least two chemical reactors to control the at least two chemical reactors such as to produce the same substance in parallel and such that they are coupled with respect two at least one operation parameter, and c) an apparatus as described above adapted to provide a control signal indicative of the determined at least one optimized coupled operation parameter to the operation unit, wherein the operation unit is adapted to control the at least two reactors based on the control signal such that an overall output of the substance of the at least two reactors is optimized.

In a further aspect of the invention, a training apparatus for training a simulated efficiency model is presented, wherein the training apparatus comprises a) a training data providing unit for providing historical training data, wherein the training data comprises a plurality of data sets comprising the at least one coupled operation parameter and a corresponding efficiency of a respective reactor, b) a trainable simulated efficiency model providing unit for providing a trainable simulated efficiency model, and c) a training unit for training the trainable simulated efficiency model by applying the trainable simulated efficiency model to the provided historical training data until the trainable simulated efficiency model is trained to determine a simulated efficiency for the respective reactor based on an at least one coupled operation parameter.

In an embodiment, the training apparatus is further adapted to retrain a trained simulated efficiency model based on retraining data comprising a currently used at least one coupled operation parameter and determined current efficiency of the respective reactor and/or additional historical data of at least one coupled operation parameters used in the past and corresponding determined efficiencies from a time period with operation conditions corresponding to current operation conditions of the respective reactor.

In a further aspect of the invention, a method for controlling a process for producing a substance is presented, wherein the process is performed at least partly by utilizing at least two coupled chemical reactors, wherein the at least two coupled reactors produce the same substance in parallel and are operated such that they are coupled with respect to at least one operation parameter, wherein the method comprises a) providing a simulated efficiency model for each of the at least two reactors, wherein a simulated efficiency model is adapted to determine a simulated efficiency of the respective reactor based on the at least one coupled operation parameter, wherein an efficiency of a reactor is indicative of the relation between an amount of an input to the respective reactor and an amount of the substance output produced by the respective reactor, b) providing an optimization model, wherein the optimization model provides an optimizable function of an overall substance output of the at least two reactors in dependency of the at least one coupled operation parameter and the efficiency of the at least two reactors, c) optimizing the overall substance output by utilizing the simulated efficiency models of the at least two reactors to determine a simulated efficiency of each of the at least two reactors and by utilizing the respective simulated efficiencies in the optimization model for determining at least one optimized coupled operation parameter that optimizes the overall substance output of the at least two reactors, and d) providing a control signal indicative of the determined at least one optimized coupled operation parameter to control the operation of that at least two reactors.

In a further aspect of the invention, a training method for training a simulated efficiency model is presented, wherein the training method comprises a) providing historical training data, wherein the training data comprises a plurality of data sets comprising at least one coupled operation parameter and a corresponding efficiency of a respective reactor, b) providing a trainable simulated efficiency model, and c) training the trainable simulated efficiency model by applying the trainable simulated efficiency model to the provided historical training data until the trainable simulated efficiency model is trained to determine a simulated efficiency for the respective reactor based on an at least one coupled operation parameter.

In a further aspect of the invention, a computer program product for controlling a process for producing a product is presented, wherein the computer program product comprises program code means for causing the apparatus as described above to carry out the method as described above.

In a further aspect of the invention, a computer program product for training a simulated efficiency model is presented, wherein the computer program product comprises program code means for causing the training apparatus as described above to carry out the training method as described above.

It shall be understood that the apparatus as described above, the system comprising the apparatus as described above, the method as described above and the computer program product as described above have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a production system for producing a substance comprising an apparatus for controlling a process for producing the substance,

FIG. 2 shows schematically and exemplarily an embodiment of a training apparatus for training a simulated efficiency model,

FIG. 3 shows schematically and exemplarily an embodiment of a method for controlling a process for producing a substance,

FIG. 4 shows schematically and exemplarily a flow chart of a training method for training a simulated efficiency model, and

FIGS. 5 and 6 show schematically and exemplarily a preferred application of the invention.

### DETAILED DESCRIPTION OF EMBODIMENTS

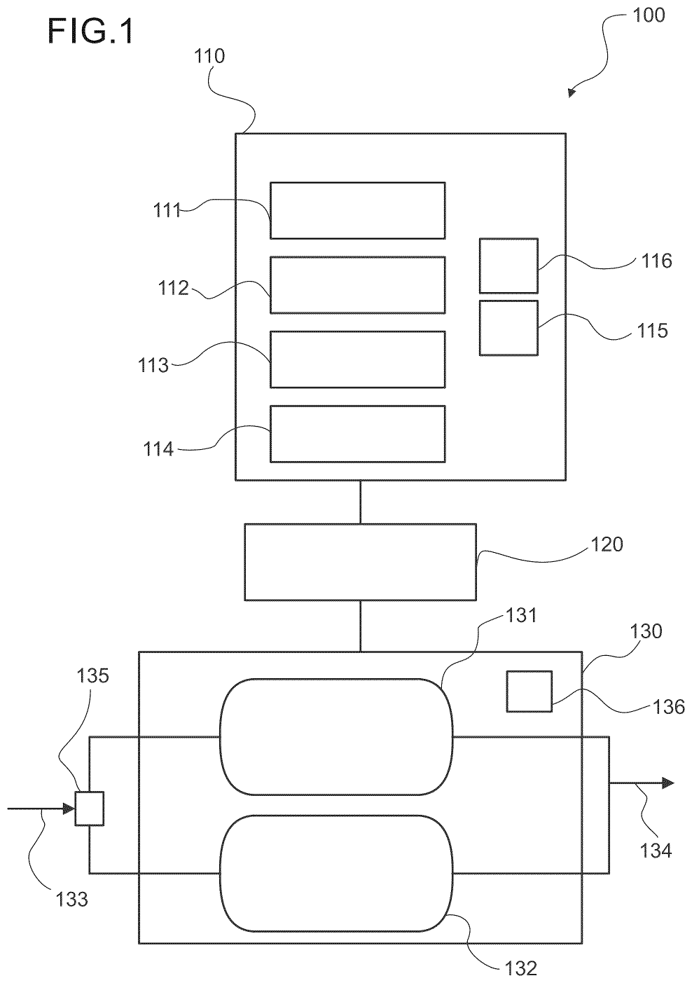

FIG. 1 shows schematically and exemplarily a production system 100 for producing a substance. The production system 100 comprises a chemical reactor system 130 comprising, in this example, two chemical reactors 131 and 132, an operation unit 120 for controlling the chemical reactor system 130 and an apparatus 110 for controlling the process for producing a substance using the chemical reactor system 130. The process for producing the substance is performed at least partly by the two reactors 131, 132, wherein in other embodiments the same principles as will be described above can also be applied to more than two reactors. The two chemical reactors 131, 132 are coupled chemical reactors that produce the same substance in parallel as output 134. The coupling of the two chemical reactors 131, 132 is in this example based on the input 133 to the two chemical reactors, wherein the input 133, for instance, one or more starting substances that are consumed in the reactors 131, 132 for producing the output 134, is provided to a valve 135 and can be divided by the valve 135 to each of the respective reactors 131, 132. In this example, the valve 135 can be controlled to increase or decrease an input to the reactor 132. At the same time the input to the reactor 131 will be decreased or increased, respectively, since the input 133 provided to the valve 135 is the same for both reactors 131, 132. Thus, in this example the reactors 131, 132 are negatively coupled to each other via an operation parameter. Moreover, in this example the chemical reactors 131, 132 are also coupled over a further operation parameter referring to the temperature. In this case, both reactors 131, 132 are operated with the same temperature, for instance, utilizing the same heating system 136 such that an increase in temperature in the reactor 131 means also an increase in temperature in the reactor 132 and vice versa. Generally, coupled reactors can also be coupled in a plurality of other alternative or additional operation parameters like a pressure in the at least two reactors, an amount of a catalyst in the at least two reactors, an amount of reactant in the at least two reactors, etc.

In this example, the chemical reactor system 130 is operated by operation unit 120 which can optionally also be regarded as part of the chemical reactor system 130. The operation of the chemical reactors 131, 132 is performed, for instance, by the operation unit 120 providing operation control signals that allow to control the chemical reactor system 130, in particular, that allow to control the operation parameters of the chemical reactor system 130. In this example, the operation parameters refer at least to the amount of input to the respective reactors 131, 132 and to the temperature of the reactors 131, 132 but can also comprise further parameters like a pressure, catalyst amount, etc. Thus, the operation control signals provided by the operation unit 120 can be regarded as control signals that allow to control in this example the valve 135 and the heating system 136. Generally, the operation unit 120 can be adapted to operate the chemical reactor system 130 automatically, for instance, together with the apparatus 110, or can be adapted to allow for an interactive operation of the chemical reactor system 130, wherein at least parts of the operation are performed by or under supervision of a user. For example, the operation unit 120 can provide a user interface that allows a user to supervise and interfere, if necessary, with the operation of the chemical reactor system 130.

The apparatus 110 is adapted for controlling the process for producing the substance as output 134 of the at least two coupled chemical reactors 131, 132, in particular, such that the output 134 of the chemical reactors 131, 132 is optimized. The apparatus 110 comprises an efficiency model providing unit 111, an optimization model providing unit 112, an optimization unit 113 and a control signal providing unit 114. Optionally, the apparatus 110 further comprises an evaluation unit 115.

The efficiency model providing unit 111 is adapted to provide a simulated efficiency model for each of the reactors 131, 132. A respective simulated efficiency model is adapted to determine a simulated efficiency of the respective reactor based on the coupled operation parameter. For example, a simulated efficiency model for reactor 131 is adapted to determine a simulated efficiency of the reactor 131 based on the input to the reactor 131 and the temperature of the reactor 131. The efficiency is generally defined for a reactor as being indicative of a relation between an amount of the input to the respective reactor and an amount of the output produced by the respective reactor. The relation between the efficiency of a reactor and the respective one or more operation parameters that is provided by the simulated efficiency model can be determined in a plurality of different ways. For example, theoretical considerations can be utilized if a relation between the efficiency of the reactor and a respective operation parameter is already known, for instance, due to physical laws or known chemical relations. For example, for the process performed by reactor 131 it can be directly derivable from physical laws how the efficiency of the reactor 131 changes with temperature. However, such a relation can also be derived empirically, for instance, utilizing measurements performed at the reactor 131 in the past. Such measurements can directly refer to the measurement of the respective operation parameter and the respective efficiency, for instance, by directly measuring the input and output of the reactor 131 of respective substances. However, since in many cases the direct measurements of an input and output of respective substances is difficult or even impossible to be measured during the operation of the reactor, also measurements that allow for an indirect determination of the efficiency can be utilized for empirically deriving a respective relation.

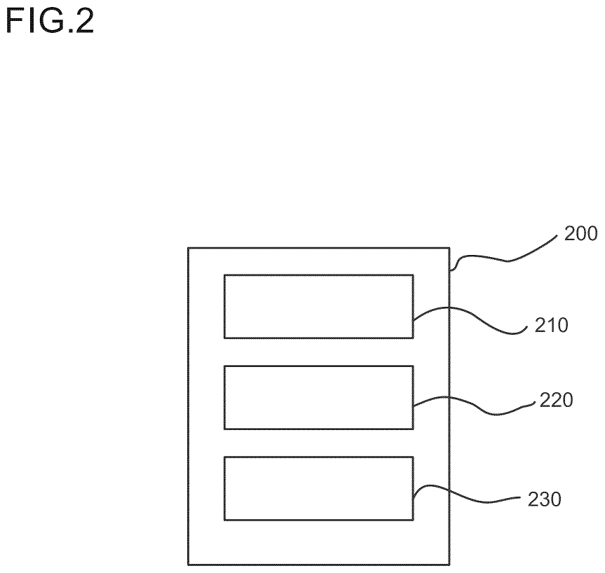

In a preferred embodiment, the simulated efficiency model refers to a trained machine learning based model, i.e. to a model that can be trained based on historical training data to find the respective relation within the respective historical training data by itself. Generally, a machine learning based simulated efficiency model can be based on any known machine learning algorithm, for instance, can be based on a neural network, a decision tree algorithm, a random forest algorithm, a regression model algorithm, etc. Such a machine learning based simulated efficiency model can then be trained utilizing, for instance, the training apparatus 200 as schematically and exemplarily shown in FIG. 2.

The training apparatus 200 adapted to train a simulated efficiency model comprises a training data providing unit 210, a trainable simulation efficiency model providing unit 220 and a training unit 230. The training data providing unit 210 can refer to or can be communicatively coupled to a respective storage unit storing historical training data or data that can be utilized as historical training data and can be adapted for providing and optionally selecting the respective historical training data. Generally, the training data comprises a plurality of data sets for a respective reactor for which the model shall be trained, wherein a data set comprises at least one coupled operation parameter, i.e. a value for the at least one coupled operation parameter, and a corresponding efficiency of the respective reactor, i.e. a corresponding value of the efficiency of the respective reactor. As already described above, the respective data sets can be provided based on historical measurements, i.e. measurements performed during the operation of the respective reactor in the past directly or indirectly, wherein an indirect determination of, for instance, the efficiency can refer to utilizing known physical laws or already known relations between measurable process parameters of the respective reactor. Process parameters can refer to any kind of physical or chemical quantity that is related to the chemical process performed by the respective chemical reactor. Thus, a process parameter can refer also to an operation parameter like a temperature but can also refer to parameters that are not controllable by an operator, for instance, a catalyst efficiency, a reaction capability of an input substance, a mass flow of a substance in an inlet or outlet of a respective reactor, a weight fraction of a substance at an inlet or outlet of a respective reactor, etc. Generally, the plurality of data sets can refer to any historical data provided for a respective reactor, however, the training data providing unit 210 can also be adapted to select respective data sets, for instance, based on similar operation parameters or reactor states for training the simulated efficiency model only for such operation parameters and such simulation states. Preferably, the plurality of data sets selected for training show a relevant variation, for example, at least three standard variations, in at least one of the process parameters. This has the advantage that the trainable simulated efficiency model is not trained based on a one-sided data set, but can alternatively learn a wide variety of possible behaviours of the respective reactor with respect to a process parameter. The training data providing unit 210 is then adapted to provide the respective training data to the training unit 230.

The trainable simulated efficiency model providing unit 220 is adapted to provide a trainable simulation efficiency model. Generally, a trainable simulated efficiency model is adapted to be trainable, for instance, by adapting one or more model parameters, to determine a simulated efficiency for a respective reactor when provided as input with the respective coupled operation parameter, i.e. a value of a respective coupled operation parameter. The trainable simulated efficiency model can be based on any known machine learning algorithm, like a neural network, a random forest algorithm, a linear regression model, etc. In particular, it is preferred that the machine learning algorithm allows the use of analytical derivatives. For example, the simulated efficiency model can utilize as machine learning algorithm a linear regression, neural network, polynomial, or ALAMO regression algorithm but also decision tree regressions or random forest algorithms can be utilized. In this case, it is preferred that for these algorithms an optimization algorithm without derivatives, for instance, utilizing a Powell's method, are used.

The trainable simulated efficiency model providing unit 220 is then adapted to provide the trainable simulated efficiency model also to the training unit 230.

The training unit 230 is then adapted to train the trainable simulated efficiency model. The training is performed, in particular, by providing the historical training data as input to the trainable simulated efficiency model until the trainable simulated efficiency model is trained to determine a simulated efficiency for the respective reactor based on the at least one coupled operation parameter. Generally, all known training methods for training a respective trainable machine learning based model can be utilized for training the simulated efficiency model. For example, the training algorithm can be selected based on the number of model parameters or the existence of variables with integer values in the trainable simulated efficiency model to be trained. Preferable methods that are utilized are based on Newton's methods, and in particular on gradient descent methods. Gradient descent methods are most suitable for trainable simulated efficiency models with a large number of trainable parameters. A such trained simulated efficiency model can then be stored, for instance, on a model database together with an identification that indicates for which reactor, operation parameter and/or operation state the model can be utilized. The efficiency model providing unit 111 can then be adapted to select for the respective reactor, for instance, for reactor 131, the respective trained simulated efficiency model from the model database and to provide the same, for instance, to the optimization unit 113.

The optimization model providing unit 112 is adapted to provide an optimization model. In particular, the optimization model providing unit 112 can be realized as a storage unit or as any hard-/software having access to a storage unit on which a respective optimization model is already stored. However, the optimization model providing unit 112 can also be realized as a receiving unit for receiving, for instance, via an input unit, the optimization model. The optimization model is adapted to provide an optimizable function of an overall substance output 134 of the two reactors 131, 132 in dependency of the at least one coupled operation parameter, in this example, the amount of input to a respective reactor and the temperature of the respective reactor, and the efficiency of the reactors 131, 132.

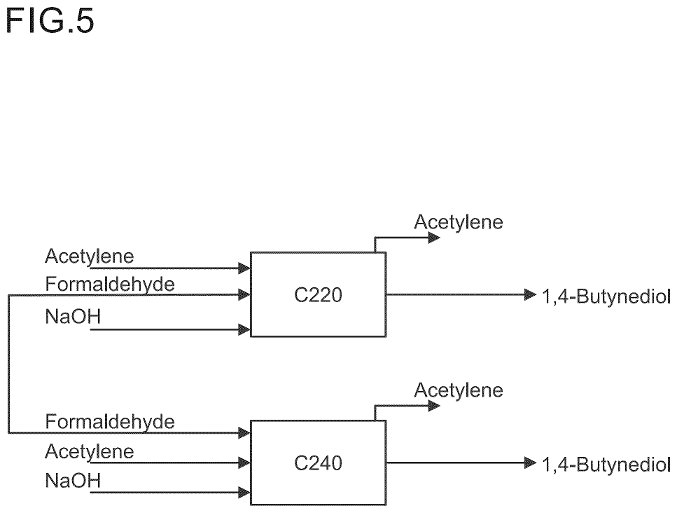

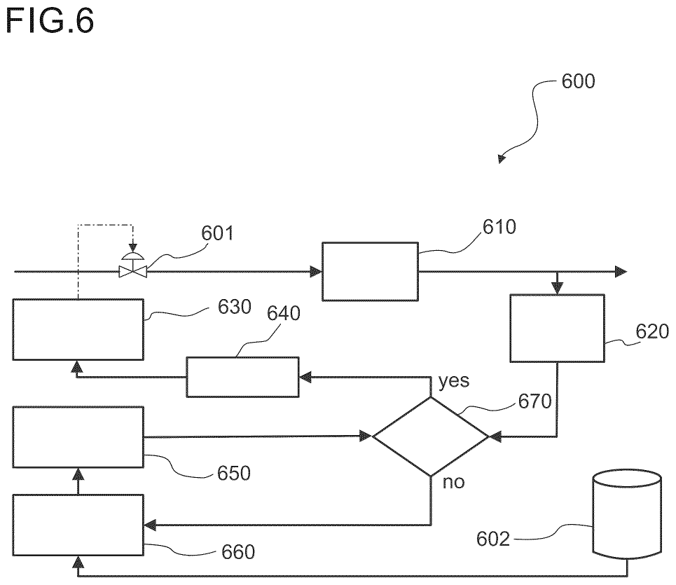

Generally, in the optimizable function the overall substance output 134 can depend on the at least one coupled operation parameter directly or indirectly via the efficiency of the at least two reactors 131, 132 that depends on the coupled operation parameter. Generally, the relation between an overall substance output and the efficiency and the coupled operation parameter can also be determined from theoretical considerations like respective physical laws or already known relations or can be determined empirically. Normally, since the efficiency of the at least two reactors 131, 132 refers also to a substance output of the at least two reactors, the dependency of the overall substance output 134 from the efficiency of the at least two reactors can be easily determined and a respective optimizable function can be provided. An example of such an optimizable function will be provided with respect to a preferred application of the invention in the description with respect to FIGS. 5 and 6. The optimization model providing unit 112 is then adapted to provide the optimization model to the optimization unit 113.

The optimization unit 113 is then adapted to optimize the overall substance output 134 of the two reactors 131, 132. For this, the optimization unit 113 utilizes the simulated efficiency model of each of the two reactors 131, 132 to determine a simulated efficiency of each of the reactors 131, 132. Further, the optimization unit 113 utilizes the optimization model for determining at least one optimized coupled operation parameter that optimizes the overall substance output of the at least two reactors 131, 132. In particular, in most cases, the optimization of the overall substance output 134 refers to a maximization of the overall substance output 134 of the at least two reactors 131, 132. However, in some examples it may also be interesting to minimize a substance output 134 of the at least two reactors, for instance, if the output of the substance is undesirable. The optimization unit 113 can be adapted to utilize known optimization methods together with the optimization model, for instance, can be adapted to utilize an iterative optimization method. In such an iterative optimization method the optimization unit 113 can be adapted to select a starting value for the coupled operation parameter and to determine using the simulated efficiency models for the starting value the respective simulated efficiencies of the reactors 131, 132. Based on these simulated efficiencies, the optimization unit 113 can then utilize the optimization model to determine the overall substance output 134 of the two reactors 131, 132. The optimization unit 113 can then be adapted to vary the starting value of the coupled operation parameter and also to determine the respective overall substance output 134 of the reactors 131, 132 based on the variations of the starting value of the coupled operation parameter. Known iterative parameter space searching algorithms can then be utilized to search the parameter space of the coupled operation parameter for values of the coupled operation parameter that optimize, i.e. maximize or minimize, depending on the respective application, the overall substance output 134 of the at least two reactors 131, 132. However, the optimization unit 113 can also be adapted to use direct optimization methods that allow for a direct solving of the optimizable function provided by the optimization model for a coupled operation parameter value, i.e. an optimized coupled operation parameter that optimizes the overall substance output of the at least two reactors. The optimized coupled operation parameter, i.e. the value of the coupled operation parameter that optimizes the overall substance output of the at least two reactors, can then be provided by the optimization unit 113 to the control signal providing unit 114.

The control signal providing unit 114 is adapted to provide a control signal indicative of the determined at least one optimized coupled operation parameter to control the operation of the two reactors 131, 132. In this example, the control signal providing unit 114 can be adapted to provide the control signal to the operation unit 120 such that the operation unit 120 can interpret the control signal, in particular, can determine from the control signal the determined at least one optimized coupled operation parameter, and, if necessary, translate the control signal to an operation control signal that is interpretable by the respective units of the chemical reactor system 130, for instance, by the valve 135 or the heating system 136, in order to implement the optimized coupled operation parameter into the chemical reactor system 130. However, in some embodiments the operation unit 120 can be regarded as being part of the control signal providing unit 114 or can even be omitted if the control signal providing unit 114 is adapted to directly provide control signals to the chemical reactor system 130 that allow a controlling of the respective units, for instance, the valve 135 and the heating system 136 of the chemical reactor system 130.

Optionally, the apparatus 110 further comprises an evaluation unit 115 adapted to regularly evaluate a simulated efficiency model of a respective reactor. Preferably, the evaluation unit 115 regularly evaluates each of the simulated efficiency models utilized for optimizing the overall substance output 134. For example, the evaluation unit 115 can be adapted to evaluate regularly the simulated efficiency model of the reactor 131 and the simulated efficiency model of the reactor 132. In particular, the evaluation unit 115 is adapted to receive a determined current efficiency of a respective reactor, for instance, reactor 131, and to compare the determined current efficiency with the simulated efficiency provided by the simulated efficiency model of the reactor for the currently used at least one coupled operation parameter. Generally, the determined current efficiency can be received from respective measurements performed in the chemical reactor system 130. Preferably, the determined current efficiency is received by a soft sensor unit 116 optionally provided by the apparatus 110. The soft sensor unit 116 is adapted to determine based on process data, in particular, based on directly measurable current process data, a current efficiency for a respective reactor. As already explained above, theoretically or empirically derived relations between measured process data and the efficiency of the respective reactor can be utilized by the soft sensor unit 116.

Since the received current efficiency of a respective reactor can be regarded as referring substantially to a current true value of the efficiency of the respective reactor for the current state of the respective reactor, a comparison with the simulated efficiency of the respective reactor allows to determine whether the simulated efficiency model still covers a current reactor state. Thus, if the evaluation unit 115 determines during the comparison, for instance, a difference between the determined current efficiency and the simulated efficiency, this difference can be taken into account during the optimization performed by the optimization unit 113. In a preferred embodiment, if the difference lies above a predetermined threshold, the optimization unit 113 is adapted, during the optimization, to adapt the simulated efficiency model, in particular, by retraining the simulated efficiency model. For example, the optimization unit 113 can utilize the training apparatus 200, as already described above, to initiate a retraining of the simulated efficiency model based on training data that comprises, for instance, the determined current efficiency of the respective reactor and/or additional historical data that refers to historical operation time periods of the reactor with similar operation conditions to current operation conditions, for instance, with substantially similar operation parameters or operation states of the reactor. This retraining then allows to provide a new simulated efficiency model that is more suitable to be utilized during a current operation state of the reactor. Thus, the optimization performed by the optimization unit 140 is for this embodiment always performed based on a simulated efficiency model that is also suitable for the current state of the respective reactor. Thus, a continuous adaptation for the simulated efficiency model is facilitated and an accuracy of the optimization is ensured also in cases in which the reactor can have different operation states.

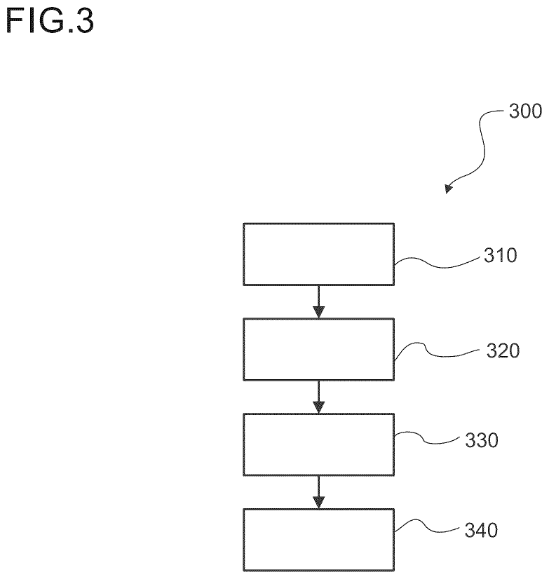

FIG. 3 shows schematically and exemplarily a method for controlling a process for producing a substance, wherein the method refers to a computer implemented method and can be performed, for instance, by the apparatus 110 as described in FIG. 1. In particular, the method can be performed in a context of a production system 100 as also described with respect to FIG. 1. The method 300 comprises a first step 310 of providing a simulated efficiency model for each of the at least two reactors. The simulated efficiency model that can be provided in this step 310 is already described above in detail. Further, the method 300 comprises a step 320 of providing an optimization model in accordance with the also already above described principles. Further, in step 330 the overall substance output is optimized by utilizing the simulated efficiency models of the at least two reactors to determine a simulated efficiency of each of the at least two reactors and by utilizing the respective simulated efficiencies in the optimization model for determining the at least one optimized coupled operation parameter that optimizes the overall substance output for the at least two reactors. In a last step 340, a control signal is then provided that is indicative of the determined at least one optimized coupled operation parameter in order to control the operations of the at least two reactors.

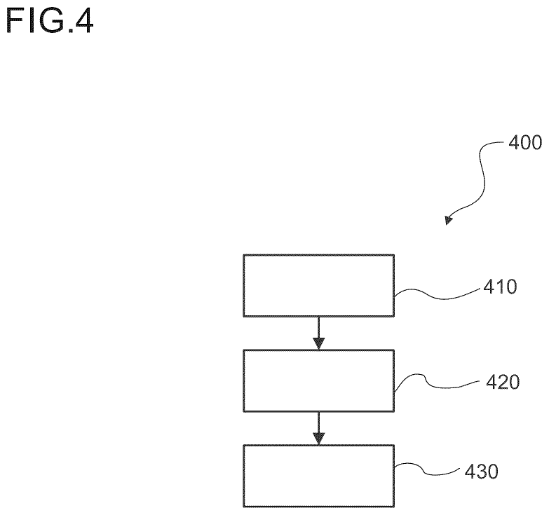

FIG. 4 shows schematically and exemplarily a method 400 for training a simulated efficiency model that can be performed, for instance, by the apparatus 200 already described with respect to FIG. 2. The training method 400 comprises a first step 410 of providing historical training data in accordance with the principles already described with respect to the training apparatus 200. Moreover, the method 400 comprises a step 420 of providing a trainable simulated efficiency model, as also already described above. In step 430, the trainable simulated efficiency model is then trained by applying the trainable simulated efficiency model to the provided historical training data until the trainable simulated efficiency model is trained to determine a simulated efficiency for the respective reactor based on at least one coupled operation parameter.

In the following the above described principles of the invention will be exemplary explained with respect to a preferred application. In a preferred embodiment, the system and apparatus are used to optimize an overall output of two coupled reactors, referred to as C220 and C240, producing 1,4-Butynediol as output substance. The two reactors are coupled in this preferred application by being fed from the same input pipeline such that an input to the two reactors is negatively coupled. Moreover, the two reactors can also be coupled positively by a temperature of the two reactors. Thus, the coupled operation parameter refers to the input to the reactors and optionally to the temperature. In this example, the method performed by the apparatus comprises preferably a soft sensor unit for estimating the individual efficiency of the reactors, and data-driven, i.e. machine learning based, simulated efficiency models that are trained with, for example, the soft sensor information, an optimization model that uses the simulated efficiency models to find the optimal input and optionally also temperatures for the reactors. Further, it is preferred that the method performed by the apparatus also comprises verifying the simulated efficiency models during their usage in the optimization and retrain them if it is needed.

The above described optimization has shown a potential capacity increase for the above system in the order of few hundred tons of substance production per year. The system is described for this example in more detail.

1,4-Butynediol is synthetized from acetylene (ACE) and formaldehyde (FA) through a catalytic reaction. The reaction is carried out in a combination of fluidized and fixed bed reactors containing copper acetylide catalyst at a pH from 5 to 8 which is regulated by the addition of sodium hydroxide (NaOH). The main reaction can be expressed in two steps as given in equation 1 (Eq. 1) that are performed in the two reactors:

C₂H₂+CH₂O→C₃H₄ C₂H₂+2 CH₂O→C₄H₆O₂. Eq.1

The first two fluidized bed reactors work in parallel and convert Acetylene and Formaldehyde into 1,4-Butynediol (BDO), as schematically illustrated in FIG. 5. However, in reality the conversion to BDO in each reactor is different, and since the reactors are normally operated at a constant and similar temperature, the difference depends mainly on catalyst activity but also on the residence time which is inversely proportional to the input.

The production of BDO at the output of the two reactors is generally not directly measured in the production plant but by combining a mass balance on each reactor and the reaction stoichiometry, it is possible to create a soft sensor model that allows to estimate the BDO production for each reactor and thus the efficiency of the two reactors. The results of the soft sensor models for each reactor can then also be utilized for developing the respective simulated efficiency models of the two reactors.

In this preferred application, the main assumption is that all FA consumed is converted to BDO exclusively according to equation 1. Data for mass and volume flows as well as density and temperature can be determined as process data and can be available, for instance, in a plant information management system (PIMs). Further, a composition of the output of the reactors can also be measured, for example, once per day. In this example, the process data can comprise an input volume flow of FA, a density of the input FA, an input mass flow of NAOH, an input mass flow of ACE, an output mass flow of ACE and an output weight fraction of FA. From these process data a soft sensor model can be determined.

Generally, from the reaction stoichiometry Eq. 1 and assuming that all of the FA consumed is converted to BDO, the BDO can be estimated from the FA consumed using equation 2 (Eq. 2),

$$( \begin{matrix}Mole BDO \\ produced\end{matrix} ) = ( \begin{matrix}Mole FA \\ consumed\end{matrix} ) \cdot 0.5 . \qquad Eq . 2$$

The FA consumed can be estimated as the difference between FA input and output. The input mass flow of FA can be measured. However, in the present example the total output flow is measured in volume and the FA contain in wt. % so that a direct estimation of the output FA mass flow is not possible and necessarily relies on an estimation of the density of the output stream, which also depends on the exact composition of it, which is unknown. A workaround can in this case be implemented considering a mass balance around the reactor so that the total output mass flow can be estimated by,

$$( \begin{matrix}overall output mass \\ flow\end{matrix} ) = input FA + input ACE + input NaOH - output ACE . \qquad Eq . 3$$

Hence, the output FA mole flow can be estimated as

$$Output mass flow FA = \frac{overall output mass flow \cdot FA weight \%}{100 \cdot Molecular {weight}_{FA}} \qquad Eq . 4$$

However, in other examples, the output mass flow, i.e. the amount of produced, substance can be directly available as measurement.

As previously shown, it is possible to estimate the absolute BDO production of each reactor. Since both reactors are operated at a similar temperature, it is plausible to assume that the difference in performance of the reactors mainly depends on the different catalyst activity and residence time. However, to a lesser extent, it also depends on temperature differences and other specifics to each reactor. For convenience all these dependencies can be expressed by the respective reactor efficiency, which is define in this example as:

$$Reactor efficiency = η = \frac{FA converted to BDO}{FA input to the reactor} \qquad Eq . 5$$

Where η=f (Catalyst acticvity, residence time, other specifics to the reactor). Based on this definition of the efficiency it can be determined how the efficiency depends on the process data and on the coupled operation parameters. For example, a direct proportionality for the efficiency with the temperature of the input can be determined based on respective measurements. Further, a principal component analysis can be performed to determine which process data is relevant for the efficiency of a respective reactor. In the respective preferred example, such a principal component analysis has shown that the efficiency can be determined by three principal components.

To optimize the output of the two reactors depending on the FA input, an optimization model with explicit dependency on the FA input is determined. It considers the overall FA input into both reactors and the FA input into one of the two reactors as parameters. The expression is given in equation 6 (Eq. 6),

$${m}_{BDO} = c \cdot ( {FA}_{C 220} \cdot {η ( {FA}_{C 220} )}_{C 220} + ( {FA}_{total} - {FA}_{C 220} ) \cdot {η ( {FA}_{total} - {FA}_{C 220} )}_{C 240} \qquad Eq . 6$$

Where m_{BDO} refers to the total BDO produced by both reactors, c is a constant relating units of FA to units of m_{BDO}, wherein, if the units are the same, for example, refer to tons/h, c=1, FA_{C220} refers to the FA input mass flow to the first reactors, FAₜₒₜₐₗ refers to a total FA input mass flow, η(FA_{C220})_{C220} refers to the efficiency of the first reactor and η(FAₜₒₜₐₗ−FA_{C220})_{C240} refers to the efficiency of the second reactor. In particular, η(FA_{C220})_{C220} and η(FAₜₒₜₐₗ−FA_{C220})_{C240} refer to the simulated efficiencies determined using the simulated efficiency models of the two reactors, respectively, that were adjusted using the available process data. Since the value of the efficiency changes with the degradation of the catalyst, an approximation provided by the simulated efficiency model can be valid just during a fixed time period, when the simulated efficiency model has only been adjusted, i.e. trained, based on training data from the respective time period. Using the simulated efficiency models for the efficiency of the reactors in Eq. 6 the optimal amount of input FA to the reactors can be determined.

Generally, the optimization model given by Eq. 6, strongly depends on the ability of the simulated efficiency model to represent the reactors efficiency accurately.

Due to the possible uncertainty of the simulated efficiency model, it is preferred that, as already described above, a real-time soft sensor unit is provided. The determined efficiency of the soft sensor can be used regularly, preferably, continuously, to verify the performance of the simulated efficiency model. If the predictions of the simulated efficiency model do not match the determined efficiency of the soft sensor unit measurements within a certain tolerance, the simulated efficiency model should be retrained using historical data. FIG. 6 shows an exemplary scheme for the optimization algorithm 600.

In the example shown in FIG. 6, the coupled operation parameter refers to an amount of input into the two reactors symbolized by the valve 601. The valve 601 determines the input into the two reactors performing the chemical process 610 for generating the substance. The chemical process is monitored by the soft sensor 620 by utilizing measurements of one or more process parameters to determine an efficiency for each of the two reactors. Further, a trained simulated efficiency model 650 is also utilized to determine the efficiency in the context of optimizing the coupled operation parameter. In step 670 the simulated efficiency is compared with the determined efficiency of the soft sensor 620. If the comparison indicates, for instance, that a difference between the simulated efficiency and the determined efficiency lies above a predetermined threshold (NO in step 670), then in step 660 the simulated efficiency model can be retrained using, for example, further historical data 602 measured for the respective reactor. The then retrained simulated efficiency model can then be utilized for determining the simulated efficiency in the optimization model. If in step 670 the difference lies below the predetermined threshold (YES in step 670), it is determined that the simulated efficiency model is accurate enough for determining the simulated efficiency. The simulated efficiency model is then utilized in the optimization model 640 for determining an optimized coupling parameter that optimizes the output of the two reactors. The optimized coupling parameter can then be utilized by a controller 630 for controlling the valve 601.

Generally, the soft sensor for estimating the efficiency of reactors as well as the numerical optimization, can be implemented as a cloud base application. This system can obtain the plant information, for instance, the process data, directly from a data lake. Respective key performance indicators or resulting optimal operation parameters can be provided or can be visualized on any PC or tablet where a browser is installed, such that no additional infrastructure is required in participating plant. The entire model for optimizing the reactor output can be used as monitoring and guiding assistance for the plant operators or can be adapted to implement control actions to drive or maintain a respective operation parameter automatically. If, for example, due to the catalyst degradation, the data-driven models for the efficiencies need to be actualized periodically, this can be done manually or automatically in the cloud implementation, for instance, as shown in FIG. 6.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the simulated efficiency model and the optimization model, the optimization of the optimization model, the generating of the control signals, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a classical computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that at least parts of the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that at least parts of the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

The invention refers to an apparatus for controlling a process for producing a substance by coupled chemical reactors being coupled with respect to an operation parameter. An efficiency model providing unit provides a model for each reactor providing a simulated efficiency of each reactor based on the operation parameter. An optimization model providing unit provides a model providing an optimizable function of a substance output of the reactors depending on the operation parameter and the efficiency of the reactors. An optimization unit optimizes the substance output by utilizing the simulated efficiency models and the respective simulated efficiencies in the optimization model for determining an optimized operation parameter that optimizes the substance output of the reactors, and a control signal providing unit provides a signal indicative of the optimized operation parameter to control the operation of the reactors.

1. An apparatus for controlling a process for producing a substance, wherein the process is performed at least partly by utilizing at least two coupled chemical reactors, wherein the at least two coupled reactors produce the same substance in parallel and are operated such that they are coupled with respect to at least one operation parameter, wherein the apparatus comprises:
an efficiency model providing unit for providing a simulated efficiency model for each of the at least two reactors, wherein a simulated efficiency model is adapted to determine a simulated efficiency of the respective reactor based on the at least one coupled operation parameter, wherein an efficiency of a reactor is indicative of the relation between an amount of an input to the respective reactor and an amount of the substance output produced by the respective reactor,
an optimization model providing unit for providing an optimization model, wherein the optimization model provides an optimizable function of an overall substance output of the at least two reactors in dependency of the at least one coupled operation parameter and the efficiency of the at least two reactors,
an optimization unit for optimizing the overall substance output by utilizing the simulated efficiency models of the at least two reactors to determine a simulated efficiency of each of the at least two reactors and by utilizing the respective simulated efficiencies in the optimization model for determining at least one optimized coupled operation parameter that optimizes the overall substance output of the at least two reactors, and
a control signal providing unit for providing a control signal indicative of the determined at least one optimized coupled operation parameter to control the operation of that at least two reactors.

2. The apparatus according to claim 1, wherein the simulated efficiency model for a reactor refers to a trained machine learning based model, wherein the simulated efficiency model is trained based on historical training data comprising the at least one coupled operation parameter and a corresponding efficiency of a respective reactor, wherein a trained simulated efficiency model is trained such that it can provide a simulated efficiency for the respective reactor based on an at least one coupled operation parameter.

3. The apparatus according to claim 1, wherein the apparatus further comprises an evaluation unit adapted to regularly evaluate the simulated efficiency model of a respective reactor, wherein the evaluation unit is adapted to receive a determined current efficiency of the respective reactor and to compare the determined current efficiency with the simulated efficiency provided by the simulated efficiency model of the reactor for the currently used at least one coupled operation parameter, wherein the optimization unit is adapted to adapt during the optimization the simulated efficiency model based on the comparison.

4. The apparatus according to claim 3, wherein the simulated efficiency model refers to a trained machine learning based model and wherein the adapting of the simulated efficiency model based on the comparison refers to a retraining of the simulated efficiency model if the comparison indicates a difference between the determined current efficiency and the simulated efficiency lying above a predetermined threshold.

5. The apparatus according to claim 4, wherein the retraining comprises utilizing retraining data comprising the currently used at least one coupled operation parameter and determined current efficiency of the respective reactor and/or additional historical data of at least one coupled operation parameters used in the past and corresponding determined efficiencies from a time period with operation conditions corresponding to the current operation conditions of the reactor.

6. The apparatus according to claim 3, wherein the apparatus further comprises a soft sensor unit adapted to determine based on current process data indicative of a current state of the process for producing the product a current efficiency for a respective reactor and to provide the determined current efficiency for the respective reactor to the evaluation unit.

7. The apparatus according to claim 6, wherein the current efficiency is determined based on process data comprising at least one of a volume flow of a substance at an inlet of the respective reactor, a reaction capability of a substance at the inlet of the respective reactor, a mass flow of a substance at the inlet of the respective reactor, a mass flow of a substance at the outlet of the respective reactor, and a weight fraction of a substance at the outlet of the respective reactor.

8. The apparatus according to claim 1, wherein the at least one coupled operation parameter refers to at least one of an inflow of a substance into the at least two reactors, a pressure in the at least two reactors, a temperature in the at least two reactors, an amount of a catalyst in the at least two reactors, and an amount of a reactant in the at least two reactors.

9. A production system for producing a substance, wherein the production system comprises:
at least two chemical reactors adapted to perform at least parts of the process for producing the substance, wherein the at least two coupled reactors are adapted to be operated such as to produce the substance in parallel and such that they are coupled with respect to at least one operation parameter,
an operation unit adapted to provide operation control signals to the at least two chemical reactors to control the at least two chemical reactors such as to produce the same substance in parallel and such that they are coupled with respect two at least one operation parameter, and
an apparatus according to claim 1 adapted to provide a control signal indicative of the determined at least one optimized coupled operation parameter to the operation unit, wherein the operation unit is adapted to control the at least two reactors based on the control signal such that an overall output of the substance of the at least two reactors is optimized.

10. A training apparatus for training a simulated efficiency model, wherein the training apparatus comprises:
a training data providing unit for providing historical training data, wherein the training data comprises a plurality of data sets comprising the at least one coupled operation parameter and a corresponding efficiency of a respective reactor,
a trainable simulated efficiency model providing unit for providing a trainable simulated efficiency model, and
a training unit for training the trainable simulated efficiency model by applying the trainable simulated efficiency model to the provided historical training data until the trainable simulated efficiency model is trained to determine a simulated efficiency for the respective reactor based on an at least one coupled operation parameter.

11. The training apparatus according to claim 10, wherein the training apparatus is further adapted to retrain a trained simulated efficiency model based on retraining data comprising a currently used at least one coupled operation parameter and determined current efficiency of the respective reactor and/or additional historical data of at least one coupled operation parameters used in the past and corresponding determined efficiencies from a time period with operation conditions corresponding to current operation conditions of the respective reactor.

12. A method for controlling a process for producing a substance, wherein the process is performed at least partly by utilizing at least two coupled chemical reactors, wherein the at least two coupled reactors produce the same substance in parallel and are operated such that they are coupled with respect to at least one operation parameter, wherein the method comprises:
providing a simulated efficiency model for each of the at least two reactors, wherein a simulated efficiency model is adapted to determine a simulated efficiency of the respective reactor based on the at least one coupled operation parameter, wherein an efficiency of a reactor is indicative of the relation between an amount of an input to the respective reactor and an amount of the substance output produced by the respective reactor,
providing an optimization model, wherein the optimization model provides an optimizable function of an overall substance output of the at least two reactors in dependency of the at least one coupled operation parameter and the efficiency of the at least two reactors,
optimizing the overall substance output by utilizing the simulated efficiency models of the at least two reactors to determine a simulated efficiency of each of the at least two reactors and by utilizing the respective simulated efficiencies in the optimization model for determining at least one optimized coupled operation parameter that optimizes the overall substance output of the at least two reactors, and
providing a control signal indicative of the determined at least one optimized coupled operation parameter to control the operation of that at least two reactors.

13. A training method for training a simulated efficiency model, wherein the training method comprises:
providing historical training data, wherein the training data comprises a plurality of data sets comprising at least one coupled operation parameter and a corresponding efficiency of a respective reactor,
providing a trainable simulated efficiency model, and
training the trainable simulated efficiency model by applying the trainable simulated efficiency model to the provided historical training data until the trainable simulated efficiency model is trained to determine a simulated efficiency for the respective reactor based on an at least one coupled operation parameter.

14. A computer program product for controlling a process for producing a product, wherein the computer program product comprises program code means for causing the apparatus of claim 1 to carry out a method for controlling a process for producing a substance, wherein the process is performed at least partly by utilizing at least two coupled chemical reactors, wherein the at least two coupled reactors produce the same substance in parallel and are operated such that they are coupled with respect to at least one operation parameter, wherein the method comprises:
providing a simulated efficiency model for each of the at least two reactors, wherein a simulated efficiency model is adapted to determine a simulated efficiency of the respective reactor based on the at least one coupled operation parameter, wherein an efficiency of a reactor is indicative of the relation between an amount of an input to the respective reactor and an amount of the substance output produced by the respective reactor,
providing an optimization model, wherein the optimization model provides an optimizable function of an overall substance output of the at least two reactors in dependency of the at least one coupled operation parameter and the efficiency of the at least two reactors,
optimizing the overall substance output by utilizing the simulated efficiency models of the at least two reactors to determine a simulated efficiency of each of the at least two reactors and by utilizing the respective simulated efficiencies in the optimization model for determining at least one optimized coupled operation parameter that optimizes the overall substance output of the at least two reactors, and
providing a control signal indicative of the determined at least one optimized coupled operation parameter to control the operation of that at least two reactors.

15. A computer program product for training a simulated efficiency model, wherein the computer program product comprises program code means for causing the apparatus of claim 10 to carry out a training method for training a simulated efficiency model, wherein the training method comprises:
providing historical training data, wherein the training data comprises a plurality of data sets comprising at least one coupled operation parameter and a corresponding efficiency of a respective reactor,
providing a trainable simulated efficiency model, and
training the trainable simulated efficiency model by applying the trainable simulated efficiency model to the provided historical training data until the trainable simulated efficiency model is trained to determine a simulated efficiency for the respective reactor based on an at least one coupled operation parameter.
